(19) United States
(12) Patent Application Publication
(10) Pub. No.: US 2015/0126250 A1
(43) Pub. Date: May 7, 2015

(54) ELECTRONIC DEVICE HAVING SOCKET DEVICE

(71) Applicant: Samsung Electronics Co., Ltd., Gyeonggi-do (KR)

(72) Inventors: Byoung-Uk YOON, Gyeonggi-do (KR); Yong-Sang YUN, Gyeonggi-do (KR)

(21) Appl. No.: 14/532,297

(22) Filed: Nov. 4, 2014

(30) Foreign Application Priority Data
Nov. 4, 2013 (KR) 10-2013-0133224
Sep. 5, 2014 (KR) 10-2014-0118696

(51) Int. Cl. H04B 1/3818

(52) U.S. Cl. CPC H04B 1/3818
USPC 455/558

(57) ABSTRACT

A socket device installed to an electronic device is provided. The electronic device includes a tray-receiving-socket comprising a plurality of connectors mounted on a substrate within an interior of the electronic device, and a tray configured to ingress and egress from the tray-receiving-socket via an opening in the electronic device, and at least partially house an additional function device operable with the electronic device when the tray is fully ingressed into the tray-receiving-socket, wherein a surface of the tray is further configured to be flush with an outer surface of the electronic device when the tray is fully ingressed into the tray-receiving-socket.

### CLAIM OF PRIORITY

This application claims the benefit under 35 U.S.C. §119(a) of a Korean patent application filed in the Korean Intellectual Property Office on Nov. 4, 2013 and assigned Serial No. 10-2013-0133224 and in the Korean Intellectual Property Office on Sep. 5, 2014 and assigned Serial No. 10-2014-0118696, the entire disclosure of which is hereby incorporated by reference.

### TECHNICAL FIELD

The present disclosure relates to an electronic device having a socket device of a card.

### BACKGROUND

An electronic device such as a mobile communication terminal has an identifying module. The identifying module is a chip or a card storing various information for authenticating a user's right to access and operate electronic device. The identifying module may therefore include, for example, a module such as a User Identify Module (UIM), a Subscriber Identify Module (SIM), and a Universal Subscriber Identify Module (USIM). Also, a mobile communication terminal has a chip type Secure Digital (SD) card, etc. as a storage medium for extending storage capacity.

For the above-listed identify module or SD card, etc., an attachment/detachment structure for detachably housing a card within a socket in the mobile communication terminal body in a drawer-like manner may be implemented. To preserve the aesthetic quality of the mobile communication terminal, the attachment/detachment structure has an outer cover that opens and closes to allow ingress and egress of the card from the terminal body, and when closed, maintains a pleasing appearance of the mobile communication terminal.

In one example of the conventional card attachment/detachment structure, the appearance cover is mounted in an opening (e.g., an entry in which a card is inserted) of an electronic device, and the card is attached/detached via a tray in which the card is placed, the tray then inserted into the opening in a drawer-like manner.

Because of the latest electronic device design trend favoring seamless aesthetics, a manufacturer encounters many design issues when adopting a separate cover because a cover separation groove may detract from the attractiveness of the appearance hinder and should thus be avoided.

Also, with the trend towards lightweight and slim profiles for electronic devices, consumers demand minimizing the size of a complimentary devices (e.g., memory cards, such as “SD cards”), and thus exertions of external forces on one particular side of the device may easily damage the complimentary devices due to the slim profile of the device.

Further, a minimal socket mechanism (e.g., such as a separation groove) integrating a holder structure but also damages the aesthetics of the device.

### SUMMARY

When an additional function device provided to an electronic device is attached/detached, a method of directly exerting external force on one or more sides of the function device has been applied, a driving space of various inner devices for this and efficiency of an operation have been studied. For example, a manual attachment/detachment method should a sufficient margin space so that a portion of a human body such as a user's finger, nail, etc., or various kinds of tools for attachment/detachment may access an auxiliary device, for attachment/detachment, and this factor acts as a determining limit of a design concept, and acts as a very inferior factor in part mounting and a slim profile of a set.

Also, an automatic attachment/detachment method makes it difficult to reduce a space occupied by various mechanisms such as an elastic body, etc. that should be provided for providing convenience to a user and gentrifying emotional quality of a device, and a concern of breakdown exists.

An aspect of the present disclosure is to provide an electronic device implemented to make an appearance of the electronic device elegant and simultaneously secure operation reliability.

Another aspect of the present disclosure is to provide an electronic device implemented to contribute to a lightweight and slim profile of the electronic device.

Still another aspect of the present disclosure is to provide an electronic device implemented to exclude possibility of destruction and breakdown upon manipulation by making manipulability easy.

In one aspect of the present disclosure, an electronic device is disclosed, comprising a tray-receiving-socket comprising a plurality of connectors mounted on a substrate within an interior of the electronic device, and a tray configured to ingress and egress from the tray-receiving-socket via an opening in the electronic device, and at least partially house an additional function device operable with the electronic device when the tray is fully ingressed into the tray-receiving-socket, wherein a surface of the tray is further configured to be flush with an outer surface of the electronic device when the tray is fully ingressed into the tray-receiving-socket.

In another aspect of the present disclosure, an electronic device is disclosed comprising a housing, including an opening formed in one side of the housing, a card socket comprising a base disposed within the housing, and a socket cover disposed over the base, forming a card-receiving space between the base and the socket cover within the housing, and a tray comprising a space configured to receiving an electronic card, the tray configured to ingress and egress from the card-receiving space, wherein at least one hooking protrusion is formed on one side of the tray, and the at least one hooking protrusion is configured to engage with a guide portion of the base to support the ingress and egress of the tray.

Various embodiments of the present disclosure may implement an elegant appearance of an electronic device, contribute to slimness and a lightweight and slim profile of the device, and exclude destruction and breakdown upon manipulation maximally, thereby securing reliability of the electronic device.

Other aspects of the disclosure will become apparent to those skilled in the art from the following detailed description, which, taken in conjunction with the annexed drawings, discloses example embodiments of the invention.

### BRIEF DESCRIPTION

The embodiments of the present disclosure will be more apparent from the following description taken in conjunction with the accompanying drawings in which:

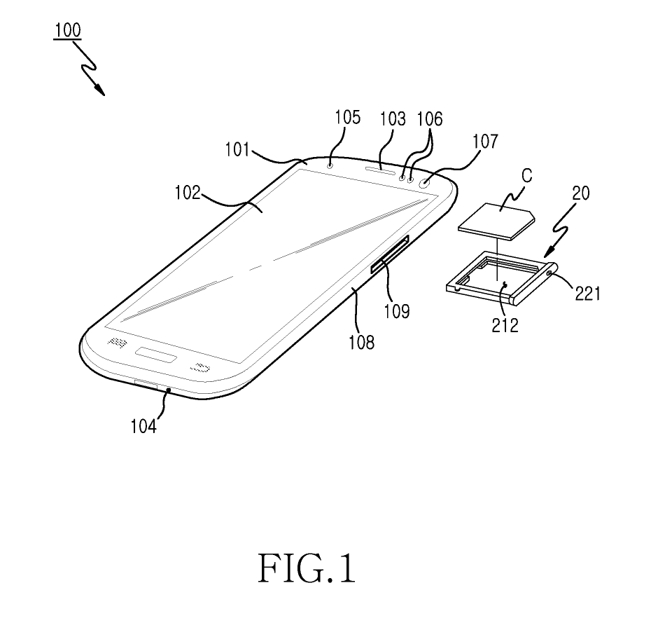

FIG. 1 is a perspective view illustrating an electronic device to which a socket device is applied according to various embodiments of the present disclosure;

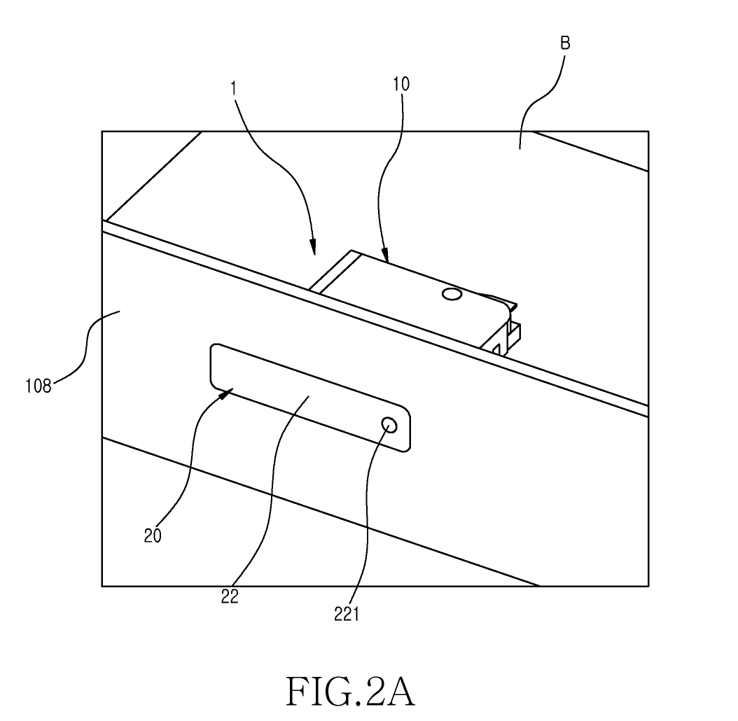

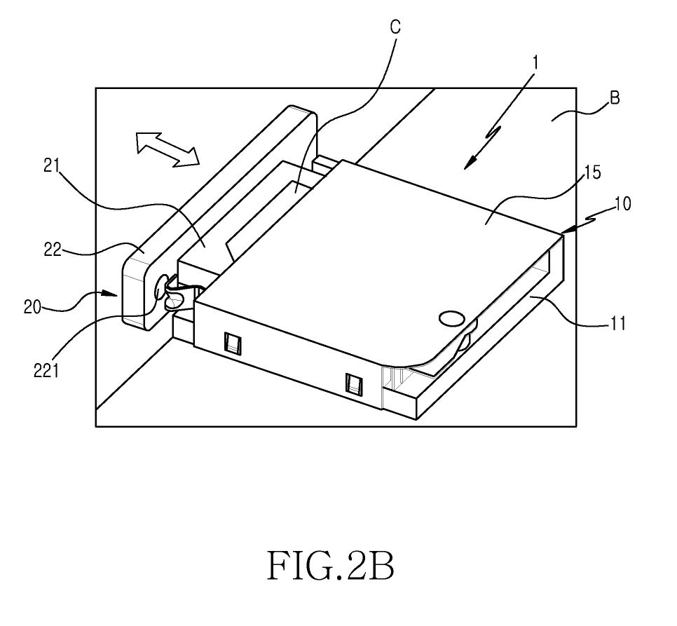

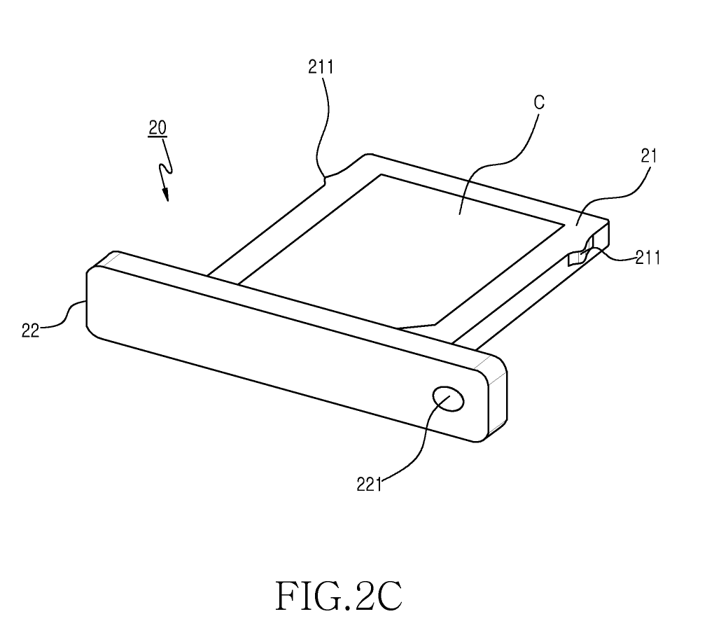

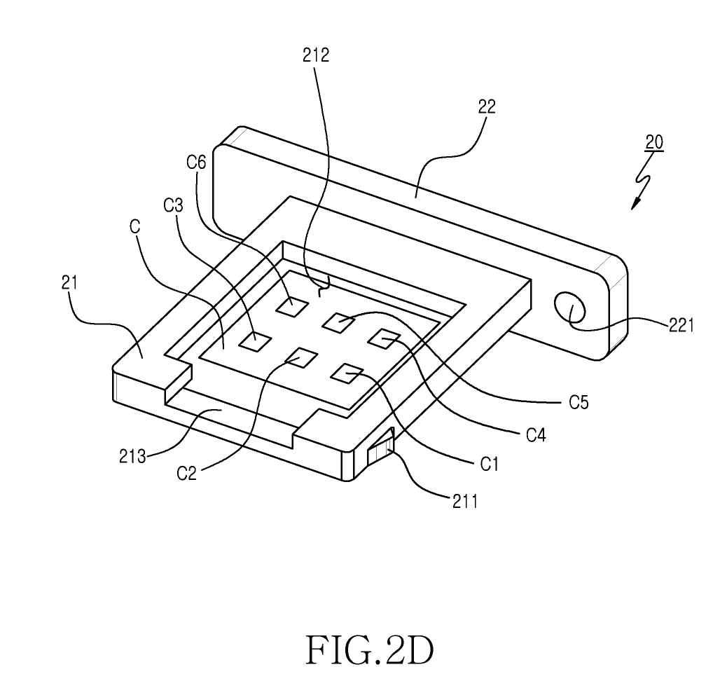

FIG. 2A, FIG. 2B, FIG. 2C and FIG. 2D are views illustrating a socket device according to an embodiment of the present disclosure;

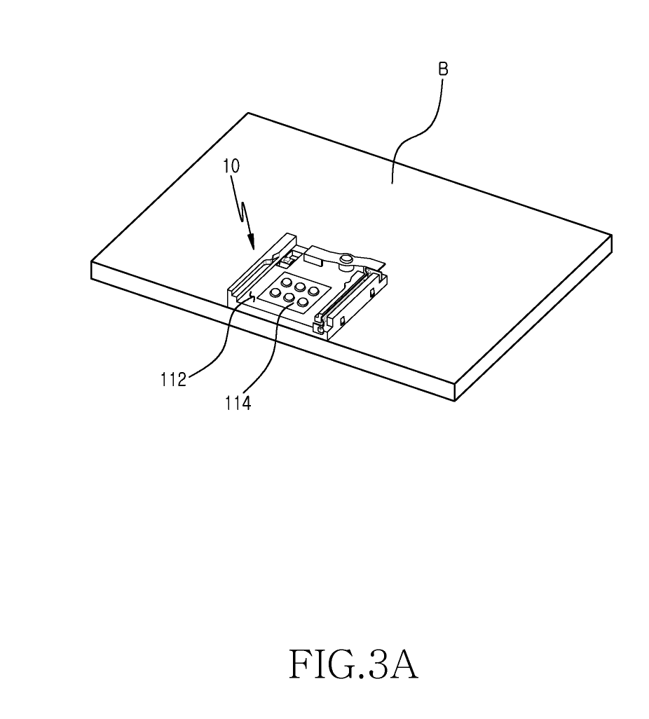

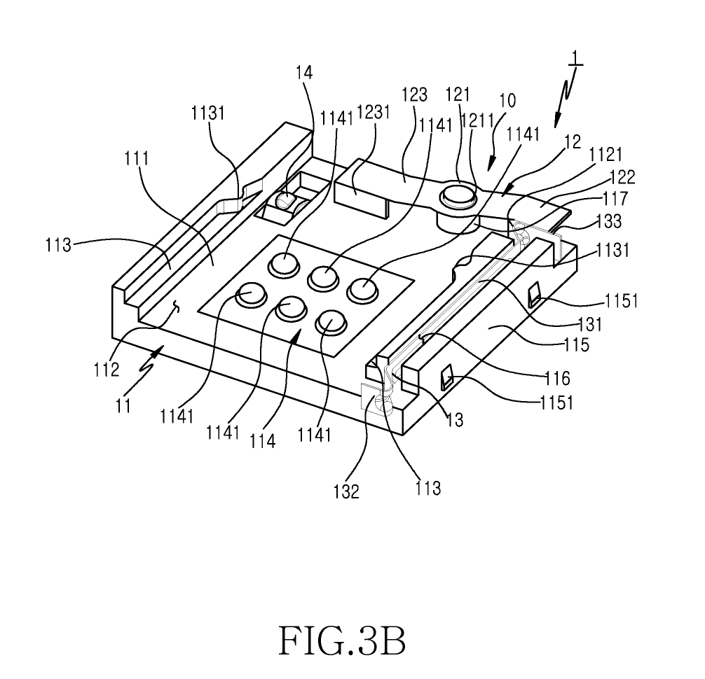

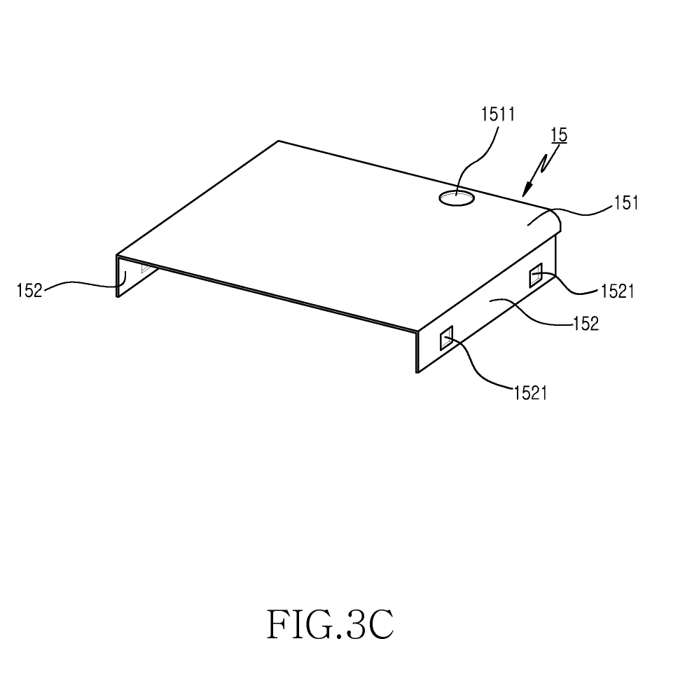

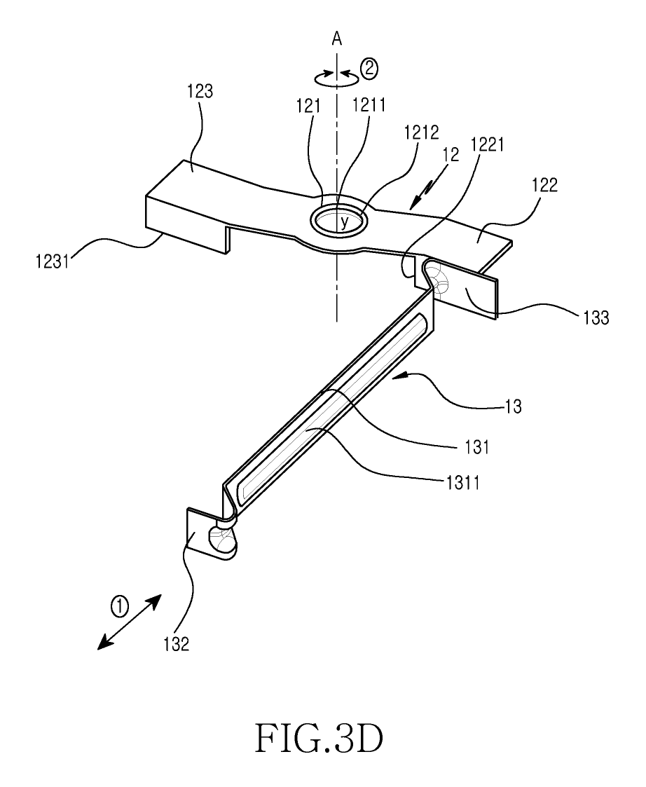

FIG. 3A, FIG. 3B, FIG. 3C and FIG. 3D are views illustrating a tray receiving socket according to an embodiment of the present disclosure;

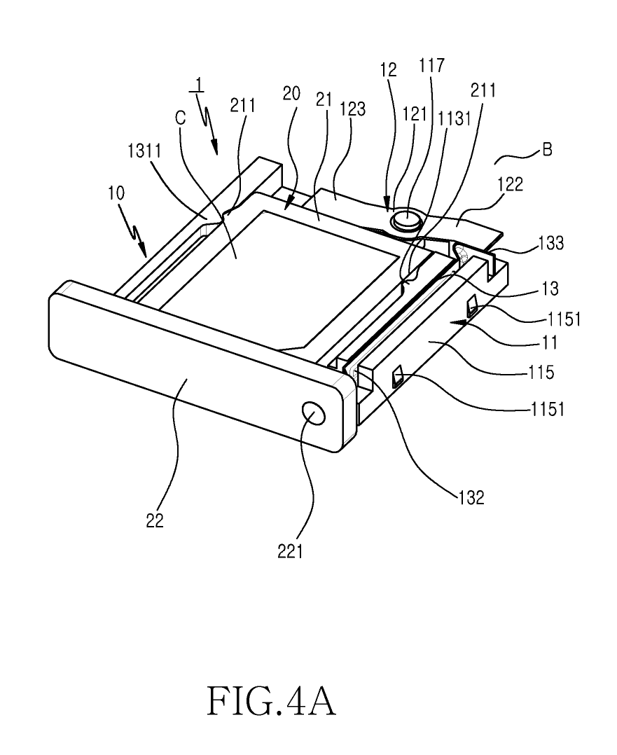

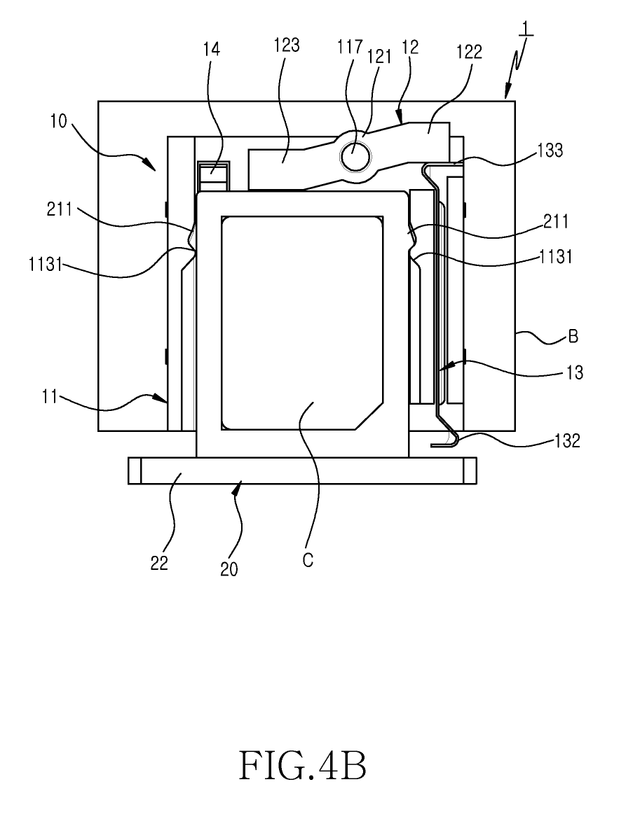

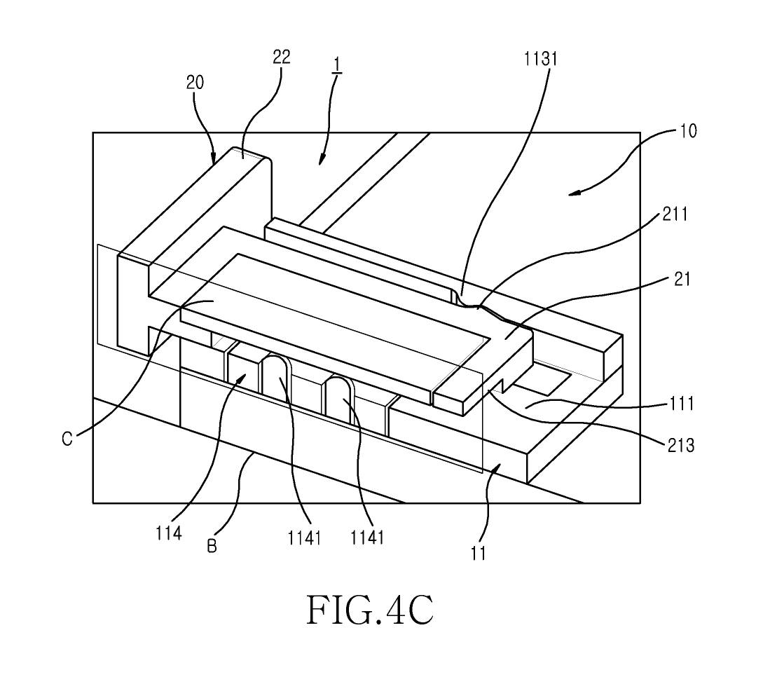

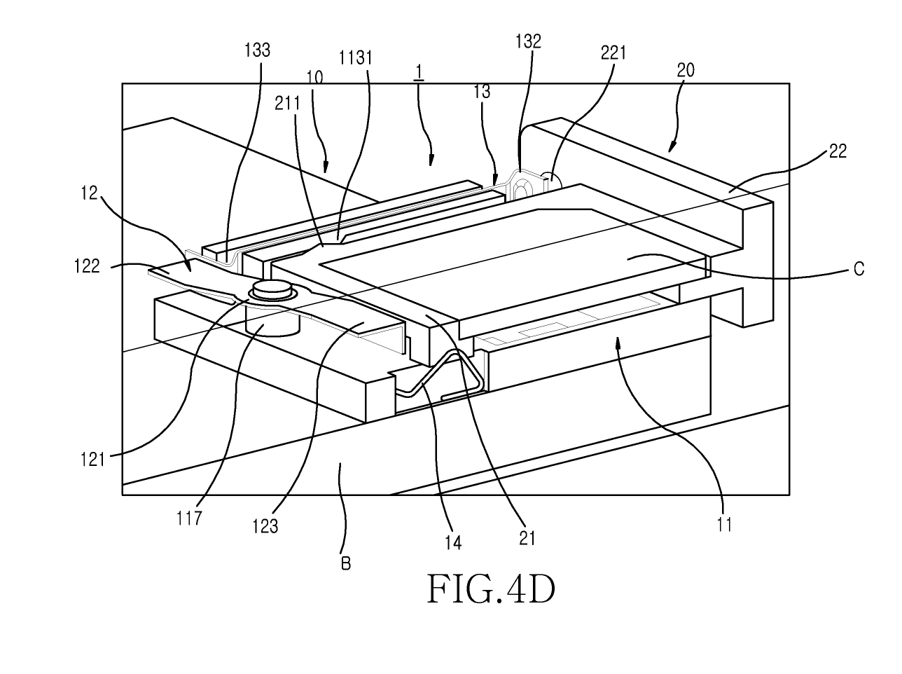

FIG. 4A, FIG. 4B, FIG. 4C and FIG. 4D are views illustrating a state where a tray is received in a tray receiving socket according to an embodiment of the present disclosure;

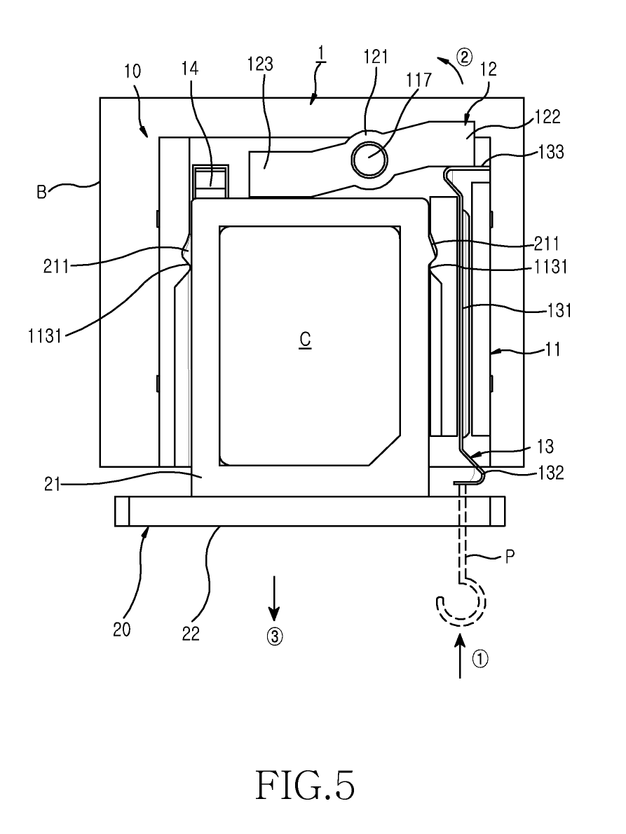

FIG. 5 is a view illustrating an application relation for separating a tray from a tray receiving socket according to an embodiment of the present disclosure;

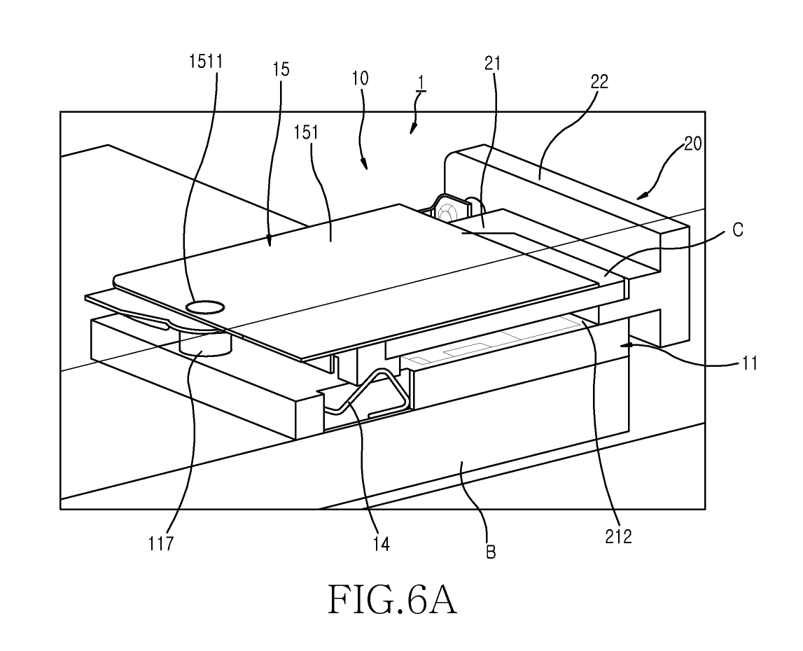

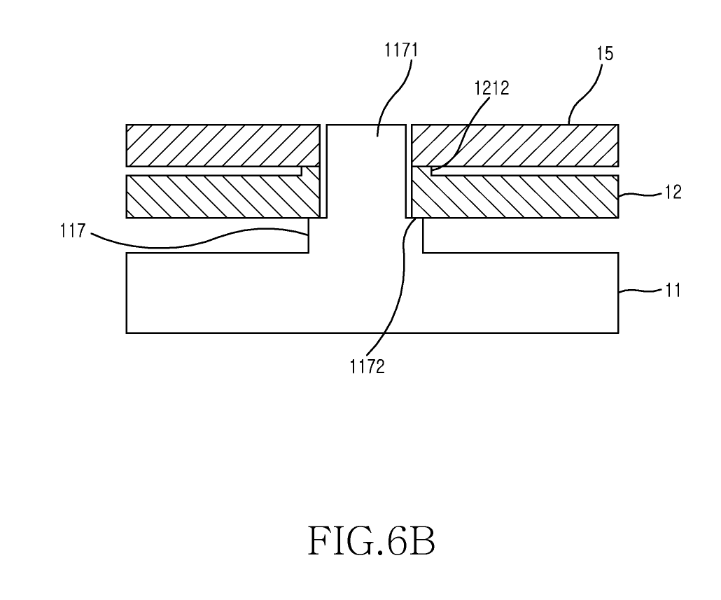

FIG. 6A and FIG. 6B are views illustrating a state where a socket cover is applied according to an embodiment of the present disclosure;

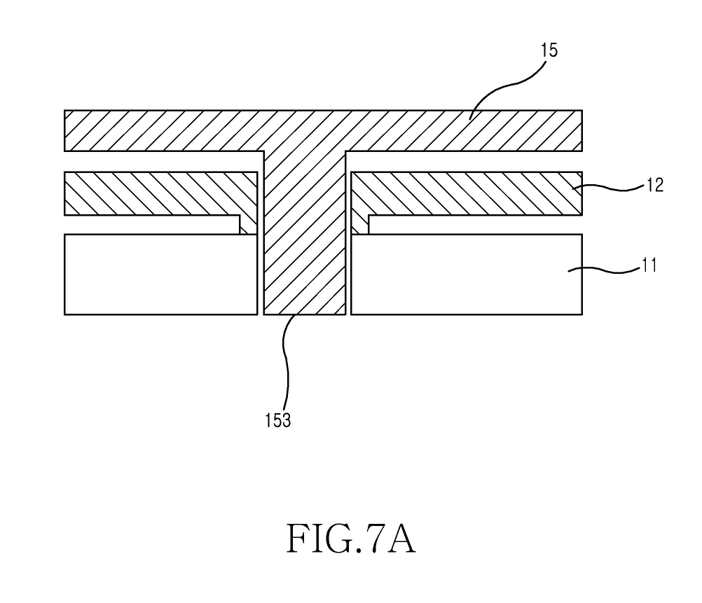

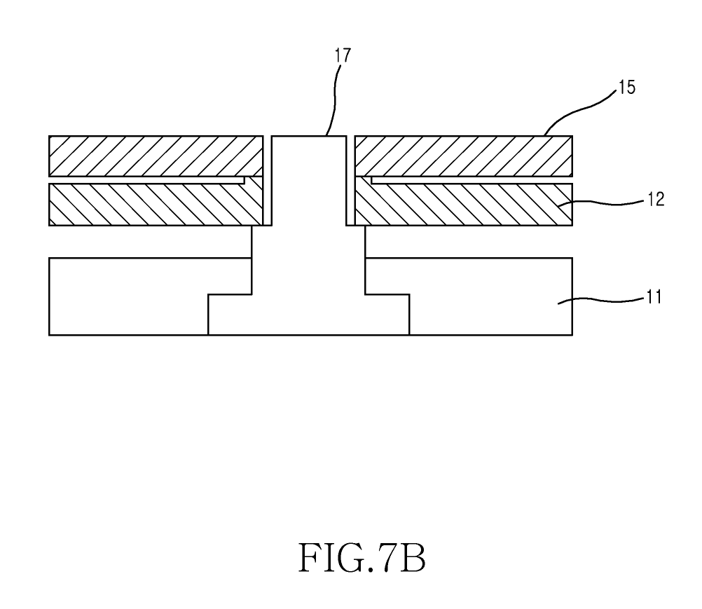

FIG. 7A and FIG. 7B are views illustrating a state where a socket cover is applied according to various embodiments of the present disclosure;

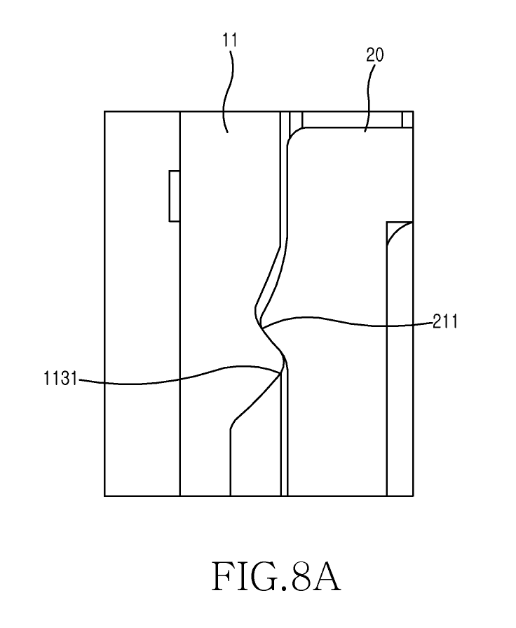

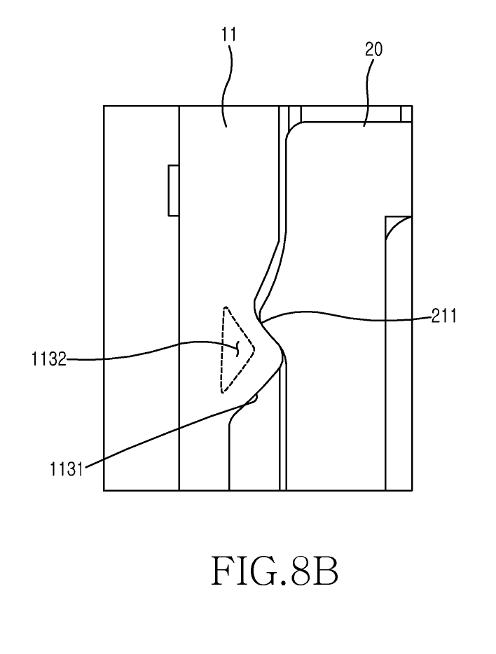

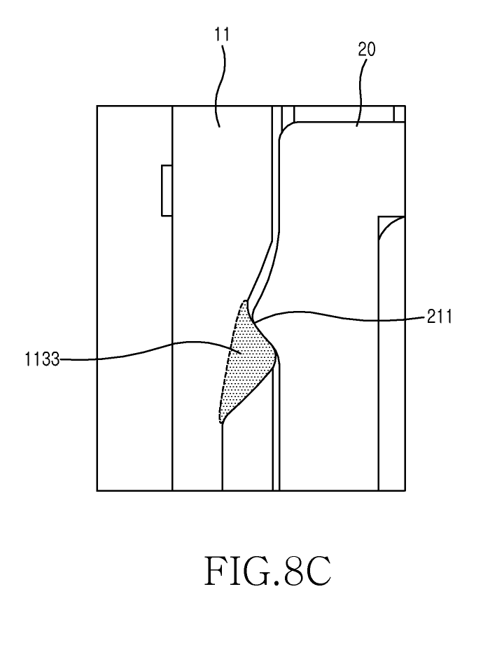

FIG. 8A, FIG. 8B and FIG. 8C are views illustrating a hooking structure of a tray according to various embodiments of the present disclosure;

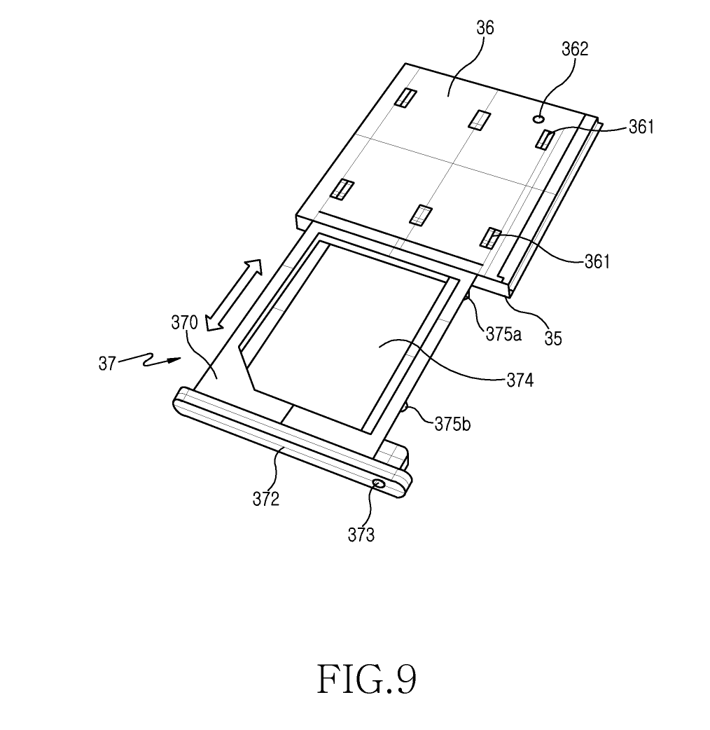

FIG. 9 is a perspective view illustrating a socket device according to various embodiments of the present disclosure;

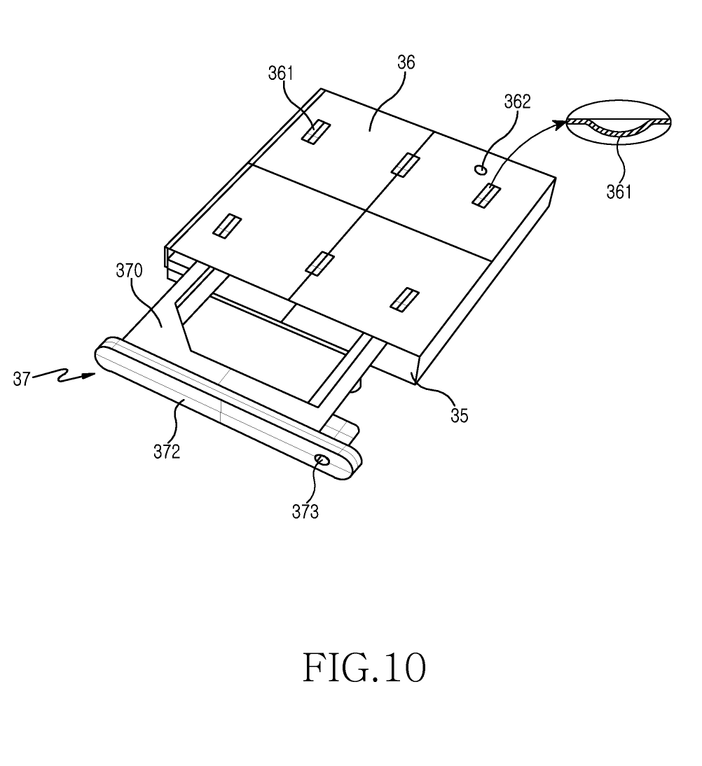

FIG. 10 is a perspective view illustrating a socket device according to various embodiments of the present disclosure and illustrating a received/drawn state;

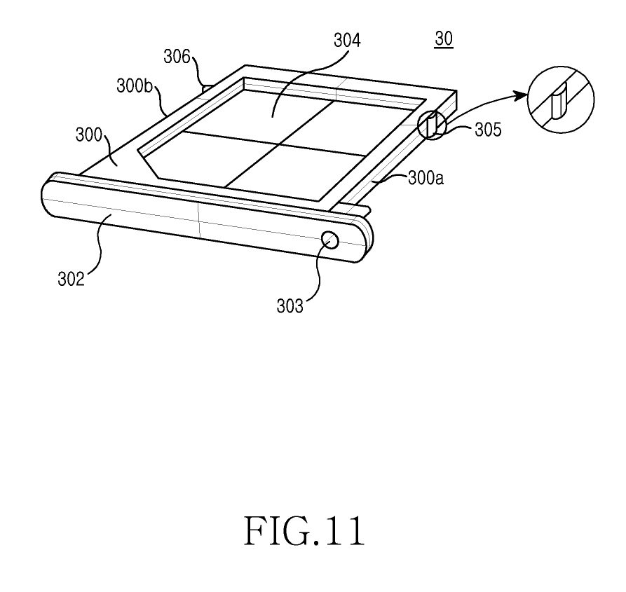

FIG. 11 is a perspective view illustrating a tray according to various embodiments of the present disclosure;

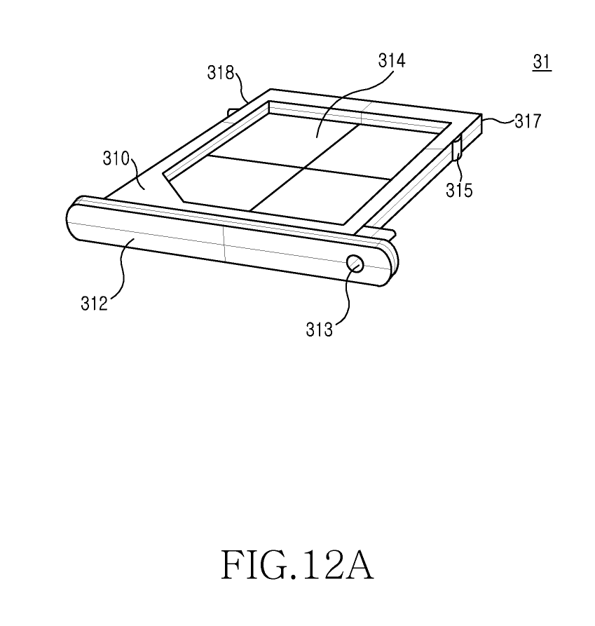

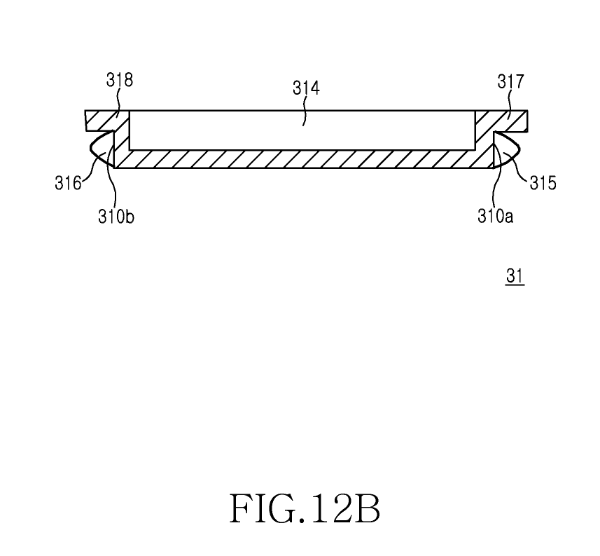

FIG. 12A is a perspective view illustrating a tray according to various embodiments of the present disclosure;

FIG. 12B is a cross-sectional view illustrating a tray according to various embodiments of the present disclosure;

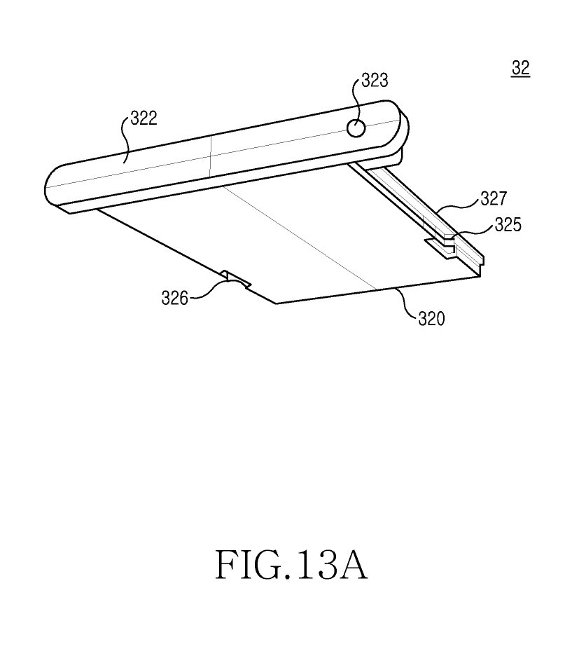

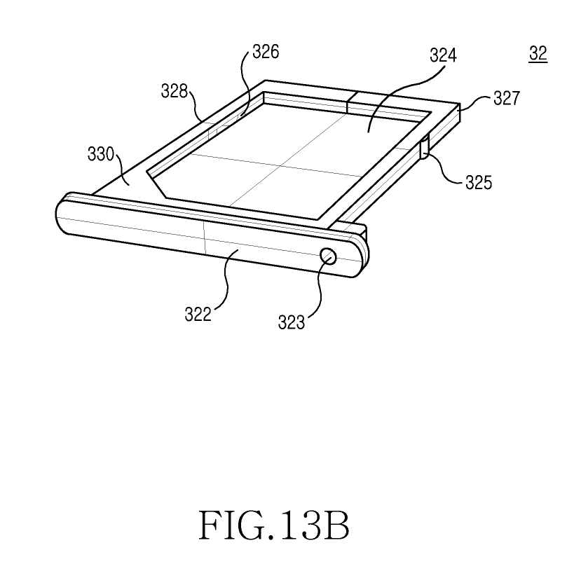

FIG. 13A and FIG. 13B are perspective views illustrating a tray according to various embodiments of the present disclosure, respectively;

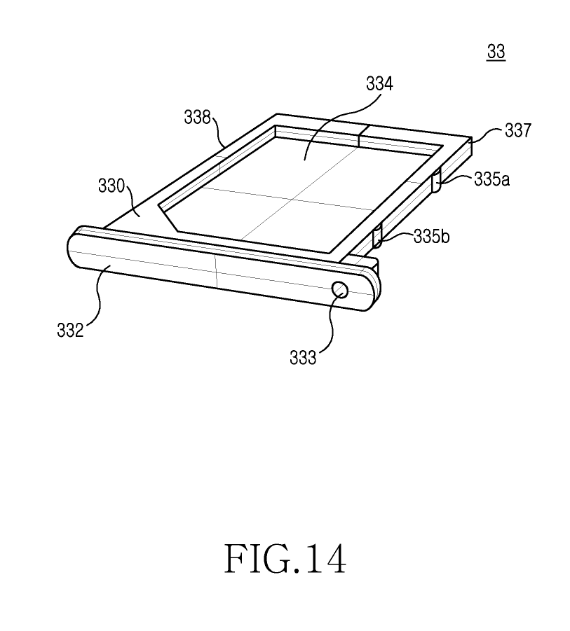

FIG. 14 is a perspective view illustrating a tray according to various embodiments of the present disclosure;

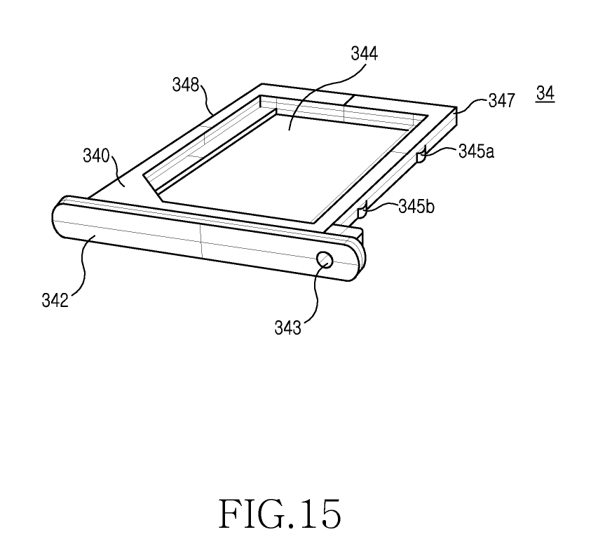

FIG. 15 is a perspective view illustrating a tray according to various embodiments of the present disclosure;

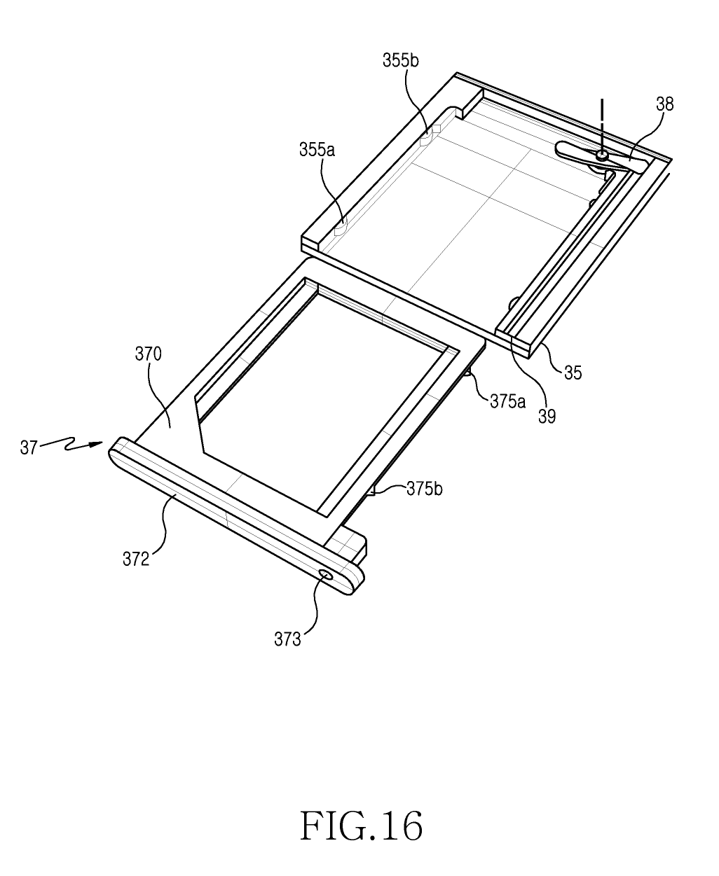

FIG. 16 is a perspective view illustrating a state where a tray is separated from a tray receiving socket according to various embodiments of the present disclosure;

FIG. 17 is a perspective view illustrating a state where a tray is coupled to a tray receiving socket according to various embodiments of the present disclosure;

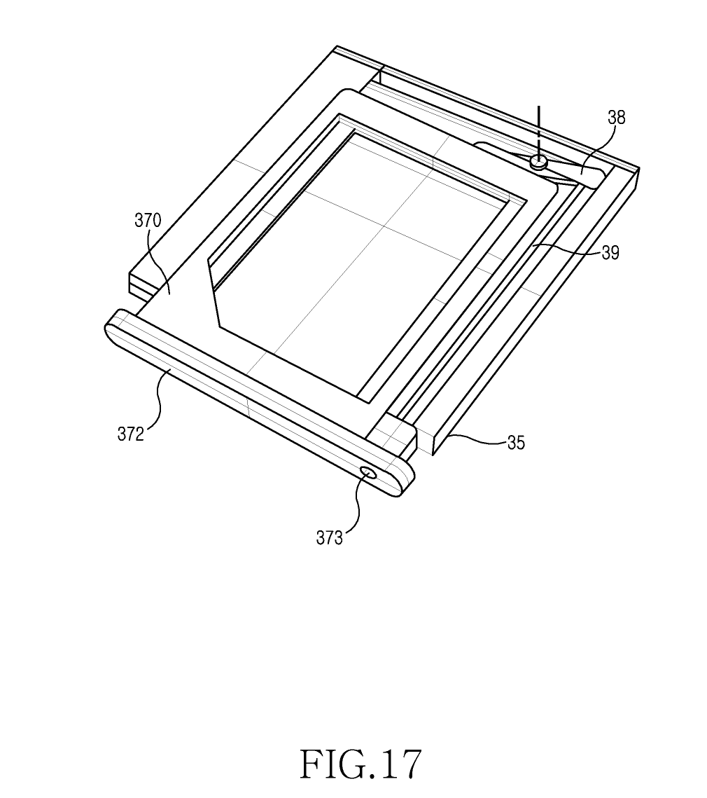

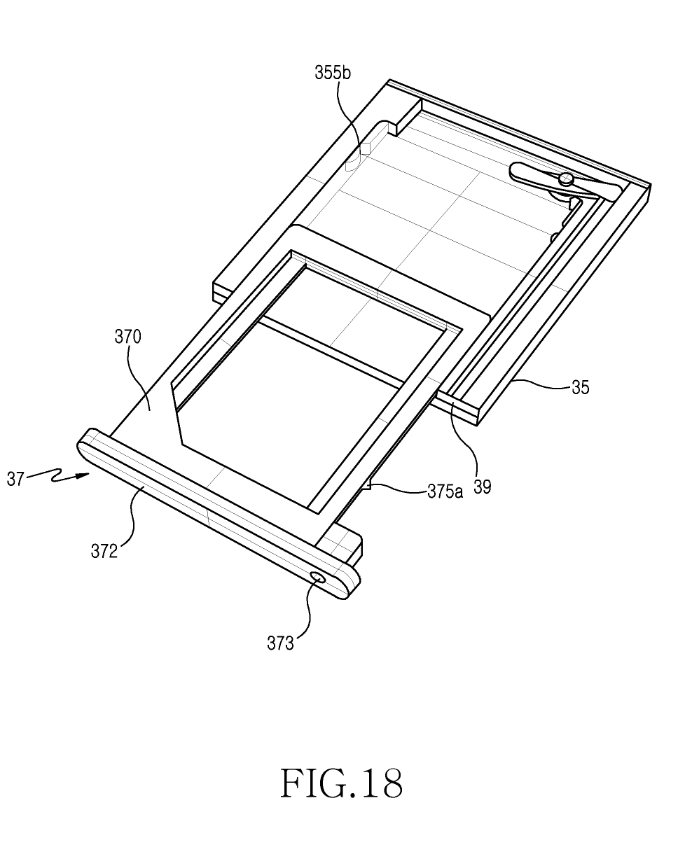

FIG. 18 is a perspective view illustrating a state where a tray is open so that a card type external device is taken out from a tray receiving socket according to various embodiments of the present disclosure;

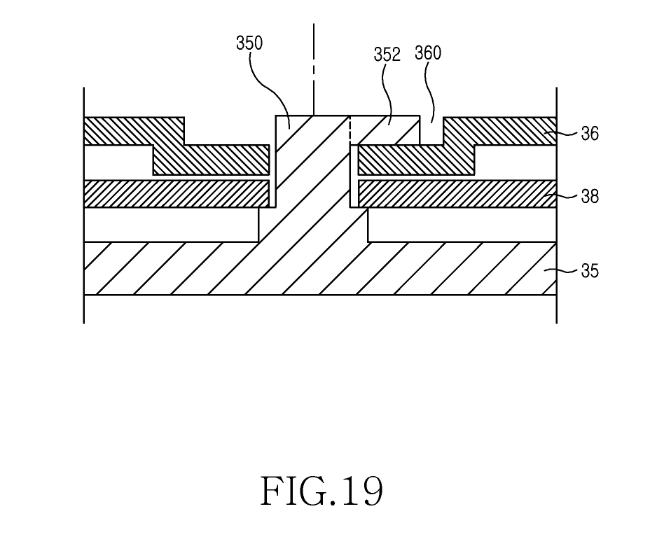

FIG. 19 is a cross-sectional view illustrating a mounting structure of a lever according to various embodiments of the present disclosure;

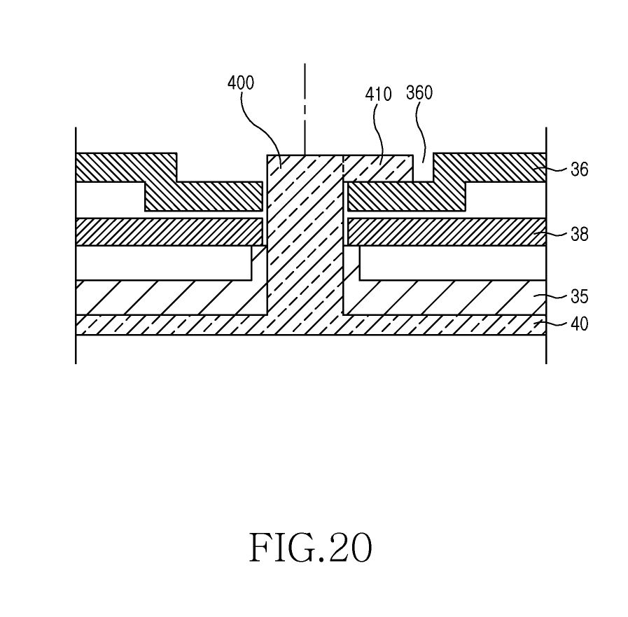

FIG. 20 is a cross-sectional view illustrating a mounting structure of a lever according to various embodiments of the present disclosure; and

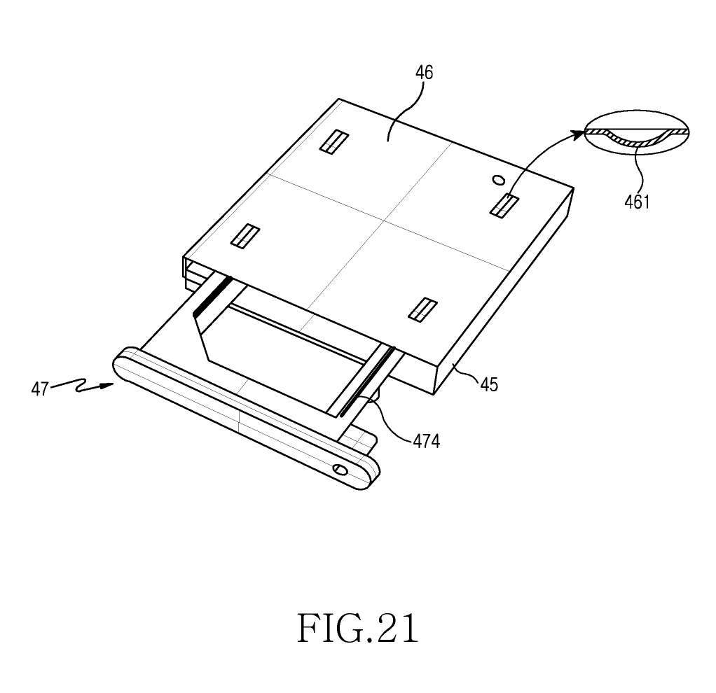

FIG. 21 is a perspective view illustrating a socket device according to various embodiments of the present disclosure and illustrating a received/drawn state.

Throughout the drawings, like reference numerals will be understood to refer to like parts, components and structures.

### DETAILED DESCRIPTION

Hereinafter, the present disclosure is described with reference to the accompanying drawings. The present disclosure may make various changes and have various embodiments, and specific embodiments are exemplarily illustrated in the drawings and related detailed descriptions are made. However, it should be understood that the specific embodiments and related detailed descriptions are not intended for limiting the present disclosure to specific embodiment forms but include all modifications and/or equivalents and substitutes thereof included in the ambit of the present disclosure. In the drawings, like reference are used for like elements.

Expressions such as “include” or “may include”, etc. that may be used for the present disclosure indicate existence of a disclosed relevant function, operation, or element, etc., and do not limit additional one or more functions, operations, or elements, etc. Also, it should be understood that terminologies such as “include” or “have”, etc. in the present disclosure are intended for designating existence of a characteristic, a number, a step, an operation, an element, a part, or a combination of these described on the specification and do not exclude in advance existence or addition possibility of one or more other characteristics, numbers, steps, operations, elements, parts, or a combination of these.

Expression such as “or”, etc. in the present disclosure includes a certain and all combinations of words listed together. For example, “A or B” may include A and may include B, or include both A and B.

In the present disclosure, expressions such as “1st”, “2nd”, “first” or “second”, etc. may modify various elements of the present disclosure but do not limit relevant elements. For example, the expressions do not limit sequence and/or importance, etc. of relevant elements. The expressions may be used for discriminating one element from another element. For example, both a first user apparatus and a second user apparatus are all user apparatuses, and represent different user apparatuses. For example, a first element may be named as a second element without departing from the scope of the present disclosure, and similarly, the second element may be named as the first element.

When it is mentioned that a certain element is “connected to” or “accesses” another element, it should be understood that the element may be directly connected to another element or may directly access another element, but still another element may exist in the middle. In contrast, when it is mentioned that a certain element is “directly connected to” or “directly accesses” another element, it should be understood that still another element may not exist in the middle.

A terminology used in the present disclosure is used for explaining a specific embodiment and is not intended for limiting the present disclosure. Unless clearly expressed otherwise, expression of the singular includes expression of the plural.

Unless defined differently, all terminologies used herein including technological or scientific terminologies have the same meaning as that generally understood by a person of ordinary skill in the art. It should be understood that generally used terminologies defined by a dictionary have meaning coinciding with meaning on context of a related technology, and unless clearly defined in the present disclosure, they are not understood as an ideal or excessively formal meaning.

An electronic device according to the present disclosure may be a device including a communication function. For example, an electronic device may include at least one of a smartphone, a tablet personal computer (PC), a mobile phone, a video phone, an e-book reader, a desktop PC, a laptop PC, a netbook computer, a Personal Digital Assistant (PDA), a Portable Multimedia Player (PMP), an MP3 player, a mobile medical device, a camera, or a wearable device (ex: a head-mounted-device (HMD) such as electronic glasses, an electronic clothing, an electronic bracelet, an electronic necklace, an electronic appcessory, an electronic tattoo, or a smartwatch).

According to certain embodiments, an electronic device may be a smart home appliance having a communication function. A smart home appliance may include, for example, at least one of a television, a Digital Video Disk (DVD) player, an audio, a refrigerator, an air conditioner, a cleaner, an oven, an electronic range, a washing machine, an air purifier, a set-top box, a TV box (for example, Samsung HomeSync™ Apple TV™, or Google TV™), game consoles, an electronic dictionary, an electronic key, a camcorder, or an electronic frame.

According to certain embodiments, an electronic device may include at least one of various medical devices (ex: Magnetic Resonance Angiography (MRA), Magnetic Resonance Imaging (MRI), Computed Tomography (CT), a shooting device, an ultrasonic device, etc.), a navigation device, a Global Positioning System (GPS) receiver, an event data recorder (EDR), a flight data recorder (FDR), an automobile infotainment device, electronic equipment for a ship (ex: a navigation device for a ship, a gyro compass, etc.), an avionics, a security device, or a robot for an industrial use or a home use.

According to certain embodiments, an electronic device may include at least one of a furniture or a portion of a building/structure including a communication function, an electronic board, an electronic signature receiving device, a projector, or various measurement devices (ex: waterworks, electricity, gas, or radio wave measuring device, etc.). An electronic device according to the present disclosure may be a combination of one or more of the above-described devices. Also, it is obvious to a person of ordinary skill in the art that the electronic device according to the present disclosure is not limited to the above-described devices.

Hereinafter, an electronic device according to various embodiments is described with reference to the accompanying drawings. A terminology of a user used in various embodiments may indicate a person who uses an electronic device or a device (ex: an artificial intelligence electronic device) that uses the electronic device.

A mobile terminal has been illustrated as an electronic device in describing the present disclosure, and a card type external device applied to this mobile terminal is illustrated and described. However, it is not limited to this mobile terminal but is applicable to various devices. For example, an electronic device may be a portable electronic device, and is applicable to a device such as a portable terminal, a mobile pad, a media player, a tablet computer, a handheld computer, or a Personal Digital Assistant (PDA). However, the present disclosure may have a card type external device receiving structure for various fixed type electronic devices such as a Personal Computer (PC) as well as these electronic devices of a portable concept.

According to various embodiments of the present disclosure, a card type external device detachably installed in an electronic device has been illustrated and described, but it has a card shape generally and the present disclosure is applicable to a non-card type external device.

According to various embodiments of the present disclosure, a socket device may be included in a single substrate, or configured on at least one separate substrate (for example, a sub substrate or a piece Printed Circuit Board (PCB)) and connected by a circuit. According to an embodiment, the socket device is applicable to both a rigid substrate and a flexible substrate.

FIG. 1 is a perspective view illustrating an electronic device to which a socket device is applied according to various embodiments of the present disclosure.

Referring to FIG. 1, a display device 102 may be installed on a front side 101 of the electronic device 100. The display device 102 may be a touchscreen where data input/output are implemented simultaneously. A microphone 104 for transmitting voice to a counterpart user may be installed on the lower side of the display device 102, and a speaker 103 for receiving a counterpart user's voice may be installed on the upper side of the display device 102. A plurality of auxiliary means 105, 106, 107 may be installed in the vicinity of the speaker 103.

As an example of the auxiliary means, a camera module 107 for shooting an object, a sensor module auxiliary means 106 including an illuminance sensor auxiliary means for sensing ambient brightness and adjusting brightness of the display device 102 or a proximity sensor for turning off a display screen during communication, etc., and a service LED auxiliary means 105 for allowing a user to visually recognize a transmission/reception state of a message, a call connection state, etc., may be installed.

According to various embodiments of the present disclosure, an exposed slit 109 (also referred to as an opening) for receiving an external device may be disposed in an outer surface of the electronic device. According to an embodiment, the slit 109 may receive a tray 20 including a card type external device C (also referred to as an “additional function device”) such that the tray 20 is detachable. According to an embodiment, the tray 20 includes an opening 212, and is implemented so that after the card type external device C is mounted in the tray 20, the tray 20 is electrically connected with contact pads disposed on the backside of the card type external device C via the opening 212.

According to various embodiments of the present disclosure, an outer surface of the electronic device 100 is not exposed with the tray 20 received in a slit 109. According to an embodiment, the tray may be installed in such a way that the tray 20 coincides with an outer surface of the electronic device 100 after the tray 20 is mounted in the electronic device 100.

According to various embodiments of the present disclosure, in situations where the intent is to install the tray 20 so that the tray 20 coincides with the outer surface of the electronic device 100, when a tool (for example, a pin, etc.) with a sharp end is inserted into an opening 221 formed in a relevant position on the outer surface of the tray 20 and accompanied by a sufficient force, the tray 20 may extend from the body of the electronic device so that the tray 20 so that a user of the electronic device 100 may remove the now protruding tray 20 from the electronic device 100 and mount or replace the card type external device C.

According to various embodiments of the present disclosure, though the card type external device C is expressed as a card type, a non-card type external devices may also be utilized together with a data input/output unit depending on the shape or size requirements of the electronic device 100, etc. According to various embodiments of the present disclosure, for an external device, an additional function device including a micro SD card, a SIM card, etc., and other such devices that may utilized as card types for the mobile terminal. However, it is not limited thereto, and a Solid State Disk (SSD) which is a detachable storage device, that is brought to the market and gradually miniaturized, etc., may be applied to an electronic device having a volume such as a PC, etc.

FIGS. 2A to 2D are views illustrating a socket device according to an embodiment of the present disclosure.

Referring to FIGS. 2A and 2B, a socket device 1 according to various embodiments of the present disclosure may include a tray receiving socket 10 disposable within the electronic device 100, and a tray 20 received in the tray receiving socket 10 and receiving the card type external device C.

According to an embodiment, the tray receiving socket 10 may be installed to a substrate B thereby forming or helping to define the slit 109 exposed to the outside of the electronic device 100. Here, the substrate B may be a PCB or an FPCB. Also, the substrate B may be a substrate formed of one piece, and may be a joint type substrate where a plurality of hard substrates are connected via a soft substrate. According to an embodiment, the tray receiving socket 10 installed to the substrate B may be disposed to receive the tray 20 via the slit 109 formed in a case frame 108 of the electronic device. According to an embodiment, the tray 20 may be mounted such that it is flush with the outer surface of the case frame 108 of the electronic device 100 when the tray 20 is completely inserted via the slit 109.

Referring to FIGS. 2C and 2D, the tray 20 may include a tray body 21 for receiving a card type external device C, and a tray cover 22 integrally formed on one end of the tray body 21. An opening 212 may be formed in the tray body 21. The opening may allow a plurality of contact pads C1, C2, C3, C4, C5, C6 (of FIG. 2D) to be disposed such that they are exposed to the backside of the card type external device C received in the tray body 21 facilitating electrical contact of a connector device 114 (of FIGS. 3A and 3B) of the tray receiving socket 10. According to an embodiment, a hooking protrusion 211 (of FIG. 2C) is formed on both sides of the tray body 21, so that when the tray 20 is mounted in the tray receiving socket 10, the hooking protrusion 211 couples to a receiving protrusion (or rod body, as described below) 131 of a base 11. Therefore, the engagement of the hooking protrusion 211 and the receiving protrusion 131 may prevent the tray 20 from being arbitrarily detached from the electronic device 100.

According to an embodiment, two or more hooking protrusions may be formed with a predetermined interval on one side of the tray body, and two or more corresponding receiving protrusions may be also formed on the base 11 to prevent the tray from moving.

According to an embodiment, a pin through hole 221 may be formed in the tray cover 22. The pin through hole 221 may be provided for receiving a pin to engage separation when the tray 20 is to be separated from the tray receiving socket 10.

FIGS. 3A to 3D are views illustrating a tray receiving socket according to an embodiment of the present disclosure.

Referring to FIGS. 3A and 3B, the tray receiving socket 10 may be installed on the upper surface of the substrate B. According to an embodiment, the tray receiving socket 10 may be fixed to the substrate B in the form of bonding, taping, and Surface Mount Device (SMD).

According to various embodiments, the tray receiving socket 10 may include the base 11 including a tray receiving space 112, a lever 12 installed to pressurize the tray 20 mounted at the end of the base 11 to an outer direction of the electronic device 100, and a push rod 13 for pressurizing the lever 12 on one side of the base 11. According to an embodiment, an electrical contact 14 may be installed inside the tray receiving space 112 of the base 11. When it encounters a force pushing it in a direction of the substrate generated by the mounting of the tray 20, a signal may be sent to a controller of the electronic device indicated that the tray 20 is mounted and installed. That is, the electric contact 14 may electrically recognize physical insertion of an additional function device (e.g., a SD card).

According to various embodiments, the base 11 may include a receiving surface 111 for receiving the tray 20. According to an embodiment, the receiving surface 111 may be disposed to have a surface lower than guide rails 113 formed on both sides of the base 11. A connector device 114 may be disposed on the receiving surface 111. According to an embodiment, the connector device 114 may be installed in the form in which a plurality of separated connectors 1141 protrude. According to an embodiment, the plurality of connectors 1141 may be disposed to positions corresponding to connectors of the card type external device C mounted thereon and received in the tray 20, that is, a plurality of contact pads C1, C2, C3, C4, C5, C6 (of FIG. 2D), respectively.

According to an embodiment, the guide rail 113 may serve to guide both sides of the tray 20, and receive the hooking protrusion 211 projecting from both sides of the tray 20. According to an embodiment, a receiving protrusion 1131 is projected on the guide rail 113 and engaged with the hooking protrusion 211 formed on both sides of the tray 20 to maintain constant engagement of the tray 20 within the tray receiving socket 10.

According to an embodiment, the lever 12 may be rotatably installed to the base 11. The lever 12 may be formed on the base 11 and rotatably installed such that the lever 12 is penetrated by a lever fixing shaft 117. The lever 12 may be rotated by pressurization of the push rod 13, and may pressurize the tray 20 received on the receiving surface 111 of the base 11 to an outer direction of the electronic device 100.

According to an embodiment, the push rod 13 may be installed in a lengthwise direction on one side of the base 11. The push rod 13 may be installed in such a way that the push rod 13 is inserted to a rod receiving slit 116 formed in a lengthwise direction on a lateral side of the base 11. According to an embodiment, the push rod 13 may be installed so that the push rod 13 may reciprocate in a back and forth direction when the push rod 13 is seated in the rod receiving slit 116 of the base 11.

Referring to FIG. 3C, with the lever 12 and the push rod 13 installed such that they are operable on the base 11, a plate type socket cover 15 may be installed thereon. The socket cover 15 may be formed of a metal material of a thin film type such as SUS, aluminum, etc. The socket cover 15 may be denoted by a shield portion, and may be a part providing force that allows an additional function device to stably maintain a connection state. The socket cover 15 may include an upper surface 151 having an area for covering the upper portion of the base 11, and a lateral side 152 cut in a height that may cover the lateral side of the base 11 from the upper surface 151. According to an embodiment, at least one protrusion receiving recess 1521 may be formed in a lateral side 115 of the socket cover 15. According to an embodiment, the protrusion receiving recess 1521 is hooked in such a way that it is seated on a cover hooking protrusion 1151 formed on both sides of the base 11 to fix the socket cover 15 to the base 11.

According to an embodiment, a shaft introduction hole 1511 may be formed in the upper surface of the socket cover 15. The shaft introduction hole 1511 may finally receive the lever fixing shaft 117 formed on the base 11, for rotatably fixing the lever 12 in such a way that the lever fixing shaft 117 passes through the shaft introduction hole 1511. Therefore, since the lever 12 is interposed between the levers fixing shaft 117 formed on the base 11 and the socket cover 15, the lever 12 is rotatable but is not detached to the outside.

According to an embodiment, since the socket cover 15 is formed in a plate type, the socket cover 15 has a predetermined shape on its upper surface in order to reinforce stiffness and press a card (pressurize function), and may include at least one bead protruding in the upward direction.

Referring to FIG. 3D, the lever 12 may include a rotator 121 rotatably installed in the lever fixing shaft 117, a rod receiver 122 extending to one side of the rotator 121 so that it is pressurized by the push rod 13 mounted on the receiving surface 111 of the base 11, and a tray pressurize portion 123 extending to other side of the rotator 121 in order to pressurize the tray 20 received in the receiving surface 111 of the base 11. According to an embodiment, the rod receiver 122 and the tray pressurize portion 123 form flanges 1221 and 1231, respectively, in the lower direction up to a position close to the receiving surface 111 of the base 11 to prevent an unbalanced rotation operation and deformation of the lever 12. According to an embodiment, a separation protrusion 1212 for separation from the socket cover 15, disposed on the upper portion along the edge of the shaft through hole 1211 of the rotator 121 may be formed. To enable swift rotation, the upper surface of the lever 12 may be implemented as to minimize a plane contact with the inner surface of the socket cover 15 installed on the upper portion. According to an embodiment, for minimum plane contact with the inner surface of the socket cover 15, a plurality of protrusions may be formed on the upper surface of the lever 12, or a plurality of burrs may be formed by a burring process.

According to an embodiment, the push rod 13 may include a rod body 131 having a predetermined length, a pin receiver 132 bent from one side of the rod body 131 and disposed at a position corresponding to the pin through hole 221 of the tray cover 22, and which a pin inserted from the outside contacts, and a lever pressurize portion 133 bent on the other side of the rod body 13, and pressurizing the rod receiver 122 of the lever 12 depending on pressurization of the pin receiver 132. According to an embodiment, for stiffness reinforcement, the plate type push rod 13 may include a bead, shape or support 1311 protruding in a lengthwise direction. According to an embodiment, when the push rod 13 moves in a direction \textcircled{1}, the lever 12 pressurized by the push rod 13 may rotate in a direction \textcircled{2} using an axis A as a rotation axis.

According to various embodiments, the base 11 may be formed of a synthetic resin injection material such as PC, etc. However, it is not limited thereto, the base 11 may be formed of metal.

According to various embodiments, the lever 12 and the push rod 11 may be formed of metal. However, they are not limited thereto, and the lever 12 and the push rod 11 may be formed of a synthetic resin.

FIGS. 4A to 4D are views illustrating a state where a tray is received in a tray receiving socket according to an embodiment of the present disclosure.

Referring to FIGS. 4A and 4B, when a card type external device C is inserted to the tray 20, the hooking protrusions 211 formed on the left/right sides of the tray 20 may overlap the receiving protrusions 1131 formed on the base 11. When the tray 20 is pressurized further to the inner side of the electronic device 100, the hooking protrusions 211 formed on both sides of the tray 20, respectively, may engage the receiving protrusions 1131 formed on the base 11, so that the hooking protrusions 211 are fixed. According to an embodiment, a point is set at which the hooking protrusion 211 completely coupled to the receiving protrusion 1311 such that the tray 20 is completely mounted in the electronic device 100.

Referring to FIGS. 4C and 4D, when the tray 20 is completely mounted in the tray receiving socket 10, the connectors 1141 protruding on the receiving surface 111 of the base 11 may electrically contact the corresponding contact pads C1, C2, C3, C4, C5, C6 (of FIG. 2D) exposed on the backside of the card type external device C via the opening 212 formed in the tray 20. According to an embodiment, a front surface of the tray 20 may further include an open end 213 (also see in FIG. 2D), that is partially open to avoid interference with the protruding connectors 1141. According to an embodiment, for the connectors 1141 protruding on the receiving surface 111 of the base 11, a C-type connector or a ball plunger may be used.

According to an embodiment, when the tray 20 is completely mounted in the tray receiving socket 10, the contact 14 is pushed to the lower side by the backside of the tray 20 and may be connected with the substrate B. According to an embodiment, the contact 14 is elastically deformable. When the tray 20 is detached from the tray receiving socket 10, the contact 14 is restored to its original form again and separated from the substrate B. According to an embodiment, by a selective separation operation between the contact 14 and the substrate B, the tray 20 being inserted may cause a signal to be transmitted to a controller of the electronic device 100, allowing the controller to track whether the tray 20 is inserted in the electronic device.

According to various embodiments, the contact 14 may protrude from the receiving surface 111 of the base 11 for receiving the tray 20. According to an embodiment, the contact 14 may be disposed at a position which may be interfered with, depending on an operation of the lever 12. According to an embodiment, the contact 14 may be disposed within an operation section that may be pressurized in a downward direction depending on rotation of the lever 12.

FIG. 5 is a view illustrating an application relation for separating a tray from a tray receiving socket according to an embodiment of the present disclosure.

Referring to FIG. 5, when removing the tray 20 from the tray receiving socket 10 of the electronic device 100 (e.g., for replacing the external device replacement or general maintenance), an operator may insert a tray separation type pin (referred to as a ‘pin’) P into the pin through hole 221 of the tray 20. The inserted pin P may contact the pin receiver 132 of the push rod 13. When a user pressurizes the pin P further to the inner direction \textcircled{1}, the pin receiver 132 of the push rod 13 is pressurized, and the lever pressurize portion 133 may pressurize the rod receiver 122 of the lever 12 using pressurizing force. As the rod receiver 122 is pressurized, when the lever 12 rotates in a direction \textcircled{2} around the rotator 121, the tray pressurize portion 123 may pressurize the tray 20 in a direction \textcircled{3}. Consequently, when the push rod 13 is pressurized in the direction \textcircled{1} by the pin P, the tray 20 may be pushed out to the direction \textcircled{3} by interaction between the push rod 13 and the lever 12.

FIGS. 6A and 6B are views illustrating a state where a socket cover is applied according to an embodiment of the present disclosure.

Referring to FIGS. 6A and 6B, the socket cover 15 may be coupled to the upper portion of the base 11. According to an embodiment, in the case where the socket cover 15 is mounted on the base 11, a portion of the upper side of the lever fixing shaft 117 protruding from the base 11 and rotatably supporting the lever 12 may pass through the shaft introduction hole 1511 of the socket cover 15. However, it is understood that the embodiments are not limited thereto, and rather that the socket cover 15 may also be fixed to the upper portion of the base 11 in such a way that a portion of the lever fixing shaft 117 is seated in a recess formed in the inner surface of the socket cover 15. This may prevent an end of the lever fixing shaft 117 from protruding to the outside of the socket cover 15.

According to various embodiments, the contact 14 may be installed in a protruding shape on the receiving surface 111 of the base 11 for receiving the tray 20. According to an embodiment, the contact 14 may be disposed at an interference position relative to the operation of the lever 12. According to an embodiment, the contact 14 may be disposed operatively such that it may be pressurized in a downward direction depending on rotation of the lever 12.

FIGS. 7A and 7B are views illustrating a state where a socket cover is applied according to various embodiments of the present disclosure.

Referring to FIG. 7A, the lever 12 may be supported by a separate shaft 153 extending from the lower portion of the socket cover 15 up to the base 11. According to an embodiment, for seating of the lever 12, the base 11 may include guide shape. In this case, a protruding portion of the lever may be temporarily assembled to the guide shape of the base 11. According to an embodiment, in the case where the shaft 153 extending from the socket cover 15 completely passes through the base 11, a through hole by the shaft may be finished using a subsidiary material such as a tape, etc., or a PCB (or FPCB), etc.

Referring to FIG. 7B, the lever 12 may be fixed using a separate piece 17 that passes through from one end of the base 11 up to the socket cover 15. According to an embodiment, the piece 17 may pass through, starting from the socket cover 15 up to the base 11. According to an embodiment, the piece 15 may be formed of metal, and may be fixed to the base 11 formed of a synthetic resin via insert molding.

FIGS. 8A to 8C are views illustrating a hooking structure of a tray according to various embodiments of the present disclosure.

FIG. 8A is a implementation view of a crucial portion illustrating a state where a hooking protrusion has completely overstridden a receiving protrusion.

As illustrated in FIG. 8B, according to an embodiment, at least one opening shape 1132 is further formed in the receiving protrusion 1131, so that elastic force may be reinforced.

As illustrated in FIG. 8C, according to an embodiment, an elastic portion 1133 may be used to replace a receiving protrusion portion with a separate elastic body. For this elastic body 1133, at least one elastic material may be selected having an elasticity greater than that of urethane, silicon, rubber, and a material of the base.

As illustrated in FIGS. 9 and 10, a socket device according to various embodiments of the present disclosure may include a base and socket cover 35 and 36, separate from the substrate of the electronic device, and a tray 37 egressed or ejected from the base and socket cover 35 and 36 in a drawer-like manner, thus receiving a card type external device (e.g., a SD card). The tray receiving socket may include a base 35 and a socket cover 36. The socket cover 36 may be fastened to the base 35. The socket cover 36 may be formed of a synthetic resin or a thin film metal. The socket cover 36 may be coupled to the base 35 to protect parts seated on the base 35 and the inner structure, and operate as a shield portion protecting components from electromagnetic waves, and have a plurality of pressurizing portions 361 to pressurize a card type external device. The pressurize operation may safely maintain a connection for the card type external device.

The socket device may be directly disposed on the substrate (not shown), disposed separately from the substrate, and/or disposed such that it is electrically connected to the substrate using a flexible circuit. A separate substrate (e.g., a substrate connected with a card type external device, and a rigid or soft substrate) may be mounted inside the socket device and electrically connected to a main substrate using the flexible circuit (also not shown).

The base and socket cover 35 and 36 installed to the inner substrate of the electronic device may be disposed to receive the tray 37 in a drawer-like manner via an opening or a slit formed in a case frame of the electronic device. According to an embodiment, the tray 37 may be mounted such that the tray 37 is flush with the outer surface of the case frame of the electronic device while the tray 37 is completely inserted via the slit.

The tray 37 may include a tray body 370 for receiving a card type external device, and a tray cover 372 integrally formed at one end of the tray body 370. An opening 374 may be formed in the tray body 370. The opening 374 may be configured to allow electric contact with a plurality of contact pads disposed such that they are exposed on the backside of the card type external device received in the tray body 370. According to an embodiment, one or more hooking protrusions 375a and 375b are formed on both sides of the tray body 370. When the tray 37 is mounted in the base and socket cover 35 and 36, the hooking protrusions 375a and 375b have a hooking structure with receiving protrusions of the base 35 (described later) to prevent the tray 37 from arbitrarily detaching from the electronic device while mounted therein.

Two or more hooking protrusions 375a and 375b may be formed on the lateral side of the tray body 370, space at a predetermined interval, and two or more corresponding receiving protrusions (shown in FIG. 16) may be also formed on the base 35 to prevent unintended movement of the tray 37. Specific description of the hooking protrusion and the receiving protrusion are described later.

A pin through hole 373 may be formed in the tray cover 372. The pin through hole 373 may be provided to receive a separation pin in when the tray body 370 is to be separated from the base and socket cover 35 and 36. An opening 362 represents a hole where a shaft providing a rotation axis of the lever is coupled.

Hereinafter, a tray according to various embodiments of the present disclosure is described with reference to FIGS. 11 to 15.

Referring to FIG. 11, a tray 30 according to various embodiments of the present disclosure may include a tray body 300, a tray cover 302, and protrusions 305 and 306. The card type external device (e.g., an additional function device) is seated within the tray body 300 after it is received. The tray cover 302 is integrally coupled to the tray body 300, and may help preserved a pleasant aesthetic appearance of the electronic device, provide ingress and egress from an opening (e.g., a slit) in the case frame of the electronic, and provide a knob whenever a user inserts or removes the tray in a drawer-like manner. The tray cover may be an external cover and serve as an opening/closing part of the slit.

The protrusions 305 and 306 may provide a resistive force maintaining a closed state or an open state of the tray.

The tray body 300 includes a card receiver 304 in which a card type external device is inserted. The card receiver 304 may be configured such that its bottom is open or closed. When the card receiver 304 is configured in an open shape (such as the shape depicted in FIG. 15), a contact portion of the card type external device may be seated such that it faces the bottom. When the bottom of the card receiver 304 is configured in a closed shape, a contact portion provided to the card type external device may be seated such that it face an upper direction. FIG. 11 illustrates an implementation wherein the bottom of the card receiver 304 is closed.

The tray cover 302 may serve to preserve a pleasant aesthetic appearance of the case frame of the electronic device when the tray 30 is completely inserted to the card receiver, and which may be disposed in a plane state same as the external surface of the case frame. A pin through hole 303 may be formed in one end region of the tray cover 302. The pin through hole 303 may be configured to allow insertion of a pin (not shown), and may linearly extend in a longitudinal direction allowing the pin to ingress and egress from the pin through hole 303.

The protrusions 305 and 306 are hooking protrusions. One or more protrusions 305 and 306 may be formed in various shapes on both sides 300a and 300b of the tray body. The hooking protrusions 305 and 306 may provide resistive force maintaining a closed state and/or an open state, when operating together with receiving protrusions and receiving recesses provided to a tray receiving socket (described later), and/or may prevent the tray from being detached from the tray receiving socket. The hooking protrusions 305 and 306 may protrude on both sides 300a and 300b of the tray body, respectively. The hooking protrusions 305 and 306 may be formed on an end region in the inner side (the portion opposite to the tray cover) of the tray body 300. The hooking protrusions 305 and 306 may be configured to extend in both multiple direction on both sides 300a and 300b of the tray body, and top surfaces of the hooking protrusions 305 and 306 may be configured in a curved shape, respectively. For example, the hooking protrusions 305 and 306 may extend in vertical directions, and protrude in horizontal or otherwise perpendicular directions relative to an axis in which the tray ingresses and egresses from the device. The position and shape in which the hooking protrusions 305 are formed 306 may be modified according to need or implementation.

Referring to FIGS. 12A and 12B, a tray 31 may include a tray body 310, a tray cover 312, and protrusions 315 and 316. Because the tray 31 of FIGS. 12A and 12B are similar to the tray 30 in implementation of the tray body 310, the tray cover 312, a pin through hole 313, and a card receiver 314, detailed description of the listed same elements is omitted. The main difference herein is in the implementation of the protrusions and a guide.

A first guide 317 and a second guide 318 may be provided to both sides 310a and 310b of the tray body 310 of the tray. The first and second guides 317 and 318 may extend along a tray ingress and egress axial direction on the upper portion of both sides 310a and 310b of the tray body, respectively. Each of the first and second guides 317 and 318 may guide an ingress and egress axial movement of the tray body.

The protrusions 315 and 316 are hooking protrusions. One or more protrusions 315 and 316 may be formed in various shapes on both sides 310a and 310b of the tray body. The hooking protrusions 315 and 316 may provide resistive force for maintaining a closed state (when close) and an open state (when open), when operating together with receiving protrusions and receiving recesses (described later), and/or may prevent the tray from being detached from the tray receiving socket. The hooking protrusions 315 and 316 may protrude on both sides 310a and 310b of the tray body, respectively. The hooking protrusions 315 and 316 may be formed on an end region in the inner side (the portion opposite to the tray cover) of the tray body 310. The hooking protrusions 315 and 316 may be configured to extend in vertical directions on both sides 310a and 310b of the tray body, and tops of the hooking protrusions 315 and 316 may be configured in a curved shape, respectively. Each of the hooking protrusions 315 and 316 may extend in a perpendicular relative to an axis in which the tray ingresses and egresses from the device. The formed position and shape of the hooking protrusions 315 and 316 may be modified variously. Also, the hooking protrusions 315 and 316 may be formed on the lower sides of the first and second guides 317 and 318, respectively. Though not shown, guide coupling structures coupled to the first and second guides 317 and 318, respectively, may be prepared in the socket receiver.

Referring to FIG. 13A and FIG. 13B, a tray 32 according to various embodiments of the present disclosure may include a tray body 320, a tray cover 322, and protrusions 325 and 326. Since the tray 32 is the same as the tray 31 in its implementation of the tray body 320, the tray cover 322, guides 327 and 328, a pin through hole 323, and a card receiver 324, detailed description of the listed same elements is omitted. The difference in its implementation of the protrusions when compared with the tray 31.

The protrusions 325 and 326 are hooking protrusions. One or more protrusions 325 and 326 may be formed in various shapes on both sides of the tray body. Each of the hooking protrusions may have a plate spring shape and may be configured to have elasticity. The shape having elasticity means that the protrusion may have a fixed end and a free end, and have a convex shape at its free end, for example, a protrusion shape.

Referring to FIG. 14, a tray 33 according to various embodiments of the present disclosure may include a tray body 330, a tray cover 332, and protrusions 335a and 335b. Since the tray 33 is the same as the tray 31 in its implementation of the tray body 330, the tray cover 332, first and second guides 337 and 338, a pin through hole 333, and a card receiver 334, detailed description of the listed same elements is omitted. The difference is in its implementation of the number of formed protrusions when compared with the tray 31.

The protrusions 335a and 335b are hooking protrusions. A plurality of protrusions 335a and 335b may be formed on one side of the tray body, and a plurality of protrusions 335a and 335b may be formed on the other side of the tray body. Also, the protrusions 335a and 335b may be symmetrically formed on both sides of the tray body. Though the protrusions formed on the other side are been shown, they may be provided on the opposing side, disposed symmetrically with the protrusions 335a and 335b.

The protrusions 335a and 335b may be formed on a front portion (a region close to the tray cover) and a rear portion (a region distant from the tray cover) on one side of the tray body 330, respectively. The formed position and shape of the protrusions 335a and 335b may be modified variously. The hooking protrusion 335b positioned at the rear portion may provide resistive force preventing the tray from being unintentionally detached when the tray is coupled in the card receiver, and the hooking protrusion 335a positioned at the front portion may provide resistive force maintaining a state where a user has drawn the tray in order to remove a card type external device.

Referring to FIG. 15, the tray 34 according to various embodiments of the present disclosure may include a tray body 340, a tray cover 342, and protrusions 345a and 345b. Since the tray 34 according to various embodiments of the present disclosure is the same as the tray 31 in its implementation of the tray body 340, the tray cover 342, first and second guides 347 and 348, a pin through hole 343, and the protrusions 345a and 345b, detailed description of the listed same elements is omitted. The difference in its implementation of a card receiver when compared with the tray 31.

The bottom of the card receiver 344 may be formed to be open. When the card receiver 344 is open, the card type external device may be received such that a contact portion faces downwards.

Hereinafter, an operation of a socket device is described with reference to FIGS. 16 to 18. FIG. 16 is a perspective view illustrating a state where a tray is separated from a tray receiving socket. FIG. 17 is a perspective view illustrating a state where a tray is coupled to a tray receiving socket. FIG. 18 is a perspective view illustrating a state where a tray is open so that a card type external device is taken out from a tray receiving socket.

The drawings illustrate a state where a socket cover has been removed.

A tray 37 may be egressed or ingressed from a base 35 in a drawer-like manner. Also, the tray 37 may be ejected using a pin (as described above) from a closed and mounted state. Since the structures for tray insertion, tray maintenance, and tray ejection between the tray 37 and the base 35 have been already described in detail, description thereof is omitted. The tray 37 may be ejected or drawn from the base 35 using a push rod 39 and a lever 38. The push rod 39 operates along a straight axis, causing the lever 38 to rotate, and thus ejected the tray 37 from the base 35 by cooperation between the push rod 39 and the lever 38. The direction of force transferred to the push rod 39 via the through hole 373 is therefore switched by the lever 38, and then the tray 37 may be pressurized in a direction of ejection.

Also, the tray 37 may be configured so that the tray 37 does not completely detach from the base 35 via a hooking structure. A plurality of hooking protrusions 375a and 375b may be formed on both sides of the tray body 370 of the tray, and a plurality of receiving protrusions may be formed on both inner sides of the base. By the engagement between hooking protrusions 375a and 375b and the receiving protrusions, the tray 370 may support a completely closed state and a completely open state, wherein in both states, the tray 370 does not detached from the base 35.

The formed positions of the hooking protrusions 375a and 375b and the receiving protrusions may be modified variously, or altered into various other shapes according to need or desire. A degree to which the tray 37 is discharged or ejected may be determined according to the formed position. Additionally, an additional hooking structure may be formed depending on the position and shape of the hooking protrusions 375a and 375b and the receiving protrusions.

Hereinafter, a mounting structure of the lever according to various embodiments of the present disclosure is described. Referring to FIGS. 19 and 20, a socket device may be configured to prevent inclination, confinement, or detachment of the lever during a rotation operation of the lever.

Referring to FIG. 19, a lever fixing shaft 350 may operate as a rotational axis of a lever 38, and may thus extend in a vertical upward direction from the base 35 to serve as a rotational axis. Also, a hooking portion 352 may be provided on the upper end of the lever fixing shaft 350. The hooking portion 352 may be disposed such that it is hooked at a step difference portion 360 formed on the socket cover 36. By coupling of the hooking portion 352 and the socket cover 36, detachment of the lever 38 may be prevented. The hooking portion 352 may be formed by bending an end of the lever fixing shaft 350 in the direction of the step difference portion 360 while the lever fixing shaft 350 is coupled to the socket cover 36.

Referring to FIG. 20, a lever fixing shaft 400 may operate as a rotational axis of the lever 38, and may thus pass through the base 35 and extend in a vertical upward direction to serve as the rotational axis. The lever fixing shaft 400 may extend in the vertical upward direction from a bottom cover 40 to operate as the rotational axis.

A hooking portion 410 may be additionally provided on the upper end of the lever fixing shaft 400. The hooking portion 410 may be disposed such that it is engaged at a step differential portion 360 formed on the socket cover 36. By coupling of the hooking portion 410 and the socket cover 36, detachment of the lever 38 may be prevented. The hooking portion 410 may be formed by bending an upper end of the lever fixing shaft 400 in the direction of the step difference portion 360 while the lever fixing shaft 400 is coupled to the socket cover 36.

FIG. 21 is a perspective view illustrating a socket device according to various embodiments of the present disclosure, illustrating an egressed or ejected state. Referring to FIG. 21, the socket device according to various embodiments of the present disclosure may include a base and socket cover 45 and 46 separated from a substrate of an electronic device, and a tray 47 that may egress or ingress from the base and socket cover 45 and 46 in a drawer-like manner, and receiving a card type external device. The receiving socket may include the base 45 and the socket cover 46. The socket cover 46 is coupled to the base 45, so that the receiving socket may be configured. The socket cover 46 may be coupled to the base 45 to play a role of protecting parts seated on the base 45 and the inner structure, and provide a shield portion operating as an electromagnetic wave shield, and further include a plurality of pressurizing portions 461 to pressurize a card type external device. The pressurize operation may safely and stably maintain a connection state of the card. Particularly, the tray 47 has a guide portion, and the guide portion may additionally have a guide groove 474. The guide groove 474 may be coupled to the pressurizing portion 461 to guide the tray 47 while supporting an ingress and egress of the tray 47.

According to various embodiments, at least a portion of a device (ex: modules or functions thereof) or a method according to the present disclosure may be implemented using an instruction stored in a computer-readable storage media in the form of a programming module, for example. The instruction, when executed by one or more processors (ex: the processor), may allow the one or more processors to perform a function corresponding to the instruction. A computer-readable storage medium may be, for example, the memory. At least a portion of the programming module may be implemented (ex: executed) by the processor, for example. At least a portion of the programming module may include, for example, a module, a program, a routine, sets of instructions or a process, etc. for performing one or more functions.

The computer-readable recording medium may include a hard disk, magnetic media such as a floppy disk and a magnetic tape, a Compact Disc Read Only Memory (CD-ROM), optical media such as a Digital Versatile Disc (DVD), magneto-optical media such as a floptical disk, and a hardware device specially configured to store and perform a program instruction (ex: a programming module) such as Read Only Memory (ROM), Random Access Memory (RAM), a flash memory, etc. Also, a program instruction may include not only a machine language code such as things generated by a complier but also a high-level language code that may be executed by a computer using an interpreter, etc. The above-described hardware device may be configured to operate as one or more software modules in order to perform an operation of the present disclosure, and vice versa.

A module or a programming module according to the present disclosure may include at least one of the above-described elements, or a portion of the elements may be omitted, or an additional another element may be further included. Operations performed by a module, a programming module, or other elements according to the present disclosure may be executed in a sequential, parallel, repetitive, or a heuristic method. Also, a portion of operations may be executed in a different sequence, omitted, or another operation may be added.

Although the invention has been shown and described with reference to certain example embodiments thereof, it will be understood by those skilled in the art that various changes in form and details may be made therein without departing from the ambit of the invention as defined by the appended claims and their equivalents. Therefore, the scope of the present disclosure should not be limited to the above-described embodiments but should be determined by not only the appended claims but also the equivalents thereof.

What is claimed is:

1. An electronic device comprising:
a tray-receiving-socket comprising a plurality of connectors mounted on a substrate within an interior of the electronic device; and
a tray configured to ingress and egress from the tray-receiving-socket via an opening in the electronic device, and at least partially house an additional function device operable with the electronic device when the tray is fully ingressed into the tray-receiving-socket,
wherein a surface of the tray is further configured to be flush with an outer surface of the electronic device when the tray is fully ingressed into the tray-receiving-socket.

2. The electronic device of claim 1, wherein the tray further comprises an electrical connector for electrically coupling to the additional function device, the electrical connector including a contact allowing a process of the electronic device to electrically recognize physical insertion of the additional function device into the tray.

3. The electronic device of claim 1, wherein the connector comprises a shield portion generating tension to additional function device to stably maintain an electrical connection with the additional function device.

4. The electronic device of claim 1, further comprising a shield portion coupled to a guide groove of the tray, the coupling of the shield portion and the guide groove providing a tension force supporting the ingress and egress of the tray from the tray-receiving-socket.

5. The electronic device of claim 1, wherein the tray further comprises:
a tray body for receiving the additional function device; and
a tray cover integrally formed with the tray body, the tray cover forming the surface flush with the outer surface of the electronic device when the tray is fully ingressed into the tray-receiving-socket.

6. The electronic device of claim 5, wherein the tray-receiving-socket comprises:
a base at least partially defining a tray receiving space;
a lever installed at an end of the base and providing tension against the tray via a rotational motion when the tray is ingressed in the tray-receiving-socket; and
a push rod installed on one side of the base and configured to moving longitudinally along an axis to tension the lever, causing the rotation motion of the lever.

7. The electronic device of claim 6, further comprising:
a rotator rotatably mounted on a lever fixing shaft protruding from a receiving surface of the base, the lever fixing shaft providing an axis of rotation for the rotation motion and the lever protruding from the rotator,
the lever further comprising:
a tray pressurize portion tensioning the tray at a first end pf the rotator when the tray is fully ingressed in the tray-receiving-socket; and
a rod receiver tensioned by the push rod at an opposing end of the rotator,
wherein when the rod receiver is tensioned by the push rod, the lever rotates around the lever fixing shaft, causing the tray pressurize portion to tension the tray to egress from the electronic device.

8. The electronic device of claim 7, wherein the push rod further comprises:
a rod body disposed on one side of the base and configured to move reciprocally;
a pin receiver formed at a first distal end of the rod body to receive tension from a pin; and
a lever pressurize portion formed a second distal end of the rod body to tension against the rod receiver in response to tension applied to the pin receiver.

9. The electronic device of claim 8, wherein each of the rod body, the pin receiver, and the lever pressurize portion further comprises at least one protruding support for reinforcing stiffness.

10. The electronic device of claim 6, further comprising a socket cover covering at least some of a upper portion of the base, including where the lever and the push rod are mounted.

11. The electronic device of claim 6, further comprising:
a lever fixing shaft protruding from a receiving surface of the base, the lever fixing shaft providing an axis of rotation for the lever, and
a hooking portion at an top distal end of the lever fixing shaft comprising a hook that prevents detachment of the lever from the lever fixing shaft.

12. The electronic device of claim 11, wherein the hooking portion further prevents inclination of the lever relative to the lever fixing shaft.

13. The electronic device of claim 11, wherein the hooking portion is formed by bending a portion of the lever fixing shaft.

14. The electronic device of claim 6, further comprising at least one hooking protrusion formed along both sides of the tray body,
at least one receiving protrusion formed along a guide rail of the base, wherein
each at least one hooking protrusion is configured to interfere with the at least one receiving protrusion to prevent the tray from fully detaching from the tray receiving socket.

15. The electronic device of claim 14, wherein at least one hooking protrusion are disposed at a distal end of the tray body opposite an end near the surface of the tray.

16. The electronic device of claim 14, wherein the receiving protrusion comprises an elastic material different than a material of the base.

17. An electronic device comprising:
a housing, including an opening formed in one side of the housing;
a card socket comprising a base disposed within the housing, and a socket cover disposed over the base, forming a card-receiving space between the base and the socket cover within the housing; and
a tray comprising a space configured to receiving an electronic card, the tray configured to ingress and egress from the card-receiving space,
wherein at least one hooking protrusion is formed on one side of the tray, and the at least one hooking protrusion is configured to engage with a guide portion of the base to support the ingress and egress of the tray.

18. The electronic device of claim 17, wherein the guide portion further comprises at least one of a receiving recess and a receiving protrusion for securing the tray when the tray is fully ingressed in the card-receiving space.

19. The electronic device of claim 18, wherein the socket cover comprises at least one pressurize portion configured to protrude and tension against the guide portion to support ingress and egress of the tray.

20. The electronic device of claim 19, wherein guide portion further includes a guide groove configured to engage with the protruding at least one pressurize portion.
